(19) United States
(12) Patent Application Publication
(10) Pub. No.: US 2005/0167034 A1
(43) Pub. Date: Aug. 4, 2005

(54) Process for producing interior trim parts

(75) Inventor: Donald R. Gearhart, Macomb, MI (US)

Correspondence Address: Robert K. Fergan;BRINKS HOFER GILSON & LIONE, P.O. Box 10395, Chicago, IL, 60610, US

(73) Assignee: W.K. Industries, Inc.

(21) Appl. No.: 10/767,565

(22) Filed: Jan. 29, 2004

(51) Int. Cl. B32B 31/00

(52) U.S. Cl. 156/212; 156/580

(57) ABSTRACT

Embodiments of the present invention provide a forming tool for forming a substrate of the interior trim part, and methods for producing the interior trim part. The interior trim part includes a substrate, a layer of cover material, and an adhesive web disposed between the foam layer and the substrate. Further, methods are provided for forming the substrate of the interior trim part and vacuum forming the cover material over the substrate.

### BACKGROUND

The present invention generally relates to interior parts for automobiles, trucks, marine vessels, and aerospace vehicles, and a process for producing such interior trim parts. Numerous types of interior trim parts are produced for use in the above mentioned industries. Parts such as headliners, instrument panels, and door and other side trim covers often feature a rigid substrate and a cover material disposed over the substrate. Often, the cover material will include a layer of foam to provide a cushioned property to the trim, as well as, to mask any defects in the underlying substrate. The substrate is typically formed by injection molding or by press forming sheet material formed of a polymer material with a filler such as a wood filler. In press forming, the sheet is heated and press-formed using metal tooling, commonly steel tooling. In addition, several hundred pounds per square inch (psi) of pressure are typically applied in forming the sheet. The initial fabrication and maintenance of the metal tooling can be both costly and time consuming.

In forming a substrate of an interior trim part, a sheet of material is typically placed between mold or die parts of a forming tool to form a substrate of the interior trim part. The sheet typically has apertures formed adjacent the outer periphery of the sheet. The forming tool has a pin frame configuration including pins that are disposed through the apertures to keep the sheet in position within the die cavity of the forming tool during forming, preventing undesirable “wrinkles” or imperfections on the resulting substrate. However, the current process of forming substrates of this type is limited in terms of complexity of configurations. The current processes of this type do not allow forming of complex configurations, e.g., interior trim panels having deep vertical walls. Moreover, with the pin frame configuration, the sheets often tear during formation.

Additionally, the cover material is typically vacuum formed over the substrate. The vacuum forming can be accomplished by disposing a substrate in a vacuum cavity, disposing the cover material over the substrate, and creating a vacuum in the vacuum cavity causing the cover material to draw down and form to the surface of the substrate. Alternatively, the prior art also provides creating the substrate with holes allowing the vacuum forming process to pull the cover material against the substrate frame through holes in the substrate. Although vacuum forming the cover material through spaces or holes in the substrate improves the vacuum forming process, a tradeoff must be made with regard to the structural integrity of the substrate.

In view of the above, it is apparent that there exists a need for an improved interior trim part and a process for producing such parts.

### SUMMARY OF THE INVENTION

In satisfying the above need, as well as overcoming the enumerated drawbacks and other limitations of the related art, an embodiment of the present invention provide a forming tool for forming a substrate of the interior trim part, and methods for producing the interior trim part. The interior trim part includes a substrate, a layer of cover material, and an adhesive disposed between the foam layer and the substrate. The substrate is made preferably of porous material and configured to provide structural form to the interior trim part. Preferably, the web adhesive is laminated to the foam layer and the cover material. In addition, the interior trim part may also include an inner panel made of porous material. The inner panel may be attached to the substrate by a fastener or directly bonded to the substrate by an adhesive layer. The panel may further include molded attachments or molded-in attachment features.

In another embodiment, the present invention includes a method of forming a substrate of the interior trim part. The method comprises providing a forming tool having a retaining portion formed at its outer periphery, heating a sheet of porous material and loosely disposing the sheet freely between a first part and a second part of the forming tool. Next, a predetermined low pressure is applied to the sheet using the first and second parts of the forming tool to form the sheet, while maintaining tension in the sheet with the retaining portion of the forming tool to retain the sheet freely between the first and second parts. The combination of using the heated porous material and applying the predetermined low pressure of between 10 and 50 psi while maintaining tension makes it possible to utilize a Ren board forming tool without retaining pins to achieve desired contours on the substrate. Ren board is a composite material that can be used for low impact tooling and generally has advantages related to the cost and speed of producing the tooling.

In yet another embodiment of the present invention, a method of vacuum forming a cover material over edges of the substrate for producing the interior trim part is also provided. The method includes positioning a porous substrate made of porous material on a vacuum forming fixture, disposing the cover material over the substrate, providing an adhesive between the substrate and cover material, heating the adhesive and the cover material, and vacuum forming the cover material to the substrate. Preferably, the substrate is made of Azdel™ to provide the substrate with a porous property. The porous property allows the vacuum to be created through the substrate and form the cover material to the substrate. Further, the adhesive is drawn into the pores of the substrate further promoting adhesion.

In still another embodiment, the present invention includes a forming tool for forming the substrate of the interior trim part. The forming tool comprises first and second mold parts between which a sheet of porous material may be loosely disposed to form the substrate. The forming tool further comprises a retaining portion or C-section formed at its outer periphery to provide tension to the sheet during forming to thereby retain the sheet between the first and second mold parts without the need of a pin frame configuration on the forming tool. The retaining portion prevents wrinkles or imperfections on the substrate, which otherwise would require retaining holes formed through the sheet through which a pin of a pin frame configuration would be disposed.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a sectional side view of an interior trim part in accordance with one embodiment of the present invention;

FIG. 2 is a sectional side view of a forming tooling for forming the sheet of substrate material in accordance with one embodiment of the present invention;

FIG. 3 is a sectional side view of the forming tool for forming the sheet of substrate material including a C-shaped section in accordance with one embodiment of the present invention;

FIG. 4 is a sectional side view of the tooling for forming the sheet of substrate material including a bend radius in accordance with one embodiment of the present invention;

FIG. 5 is a sectional view of the substrate, cover material, and a vacuum forming fixture for vacuum forming the cover material to the substrate of the interior trim part in accordance with one embodiment of the present invention;

FIG. 6 is a flowchart of a general method of producing an interior trim part;

FIG. 7 is a flowchart of a method of forming substrate for an interior trim part; and

FIG. 8 is a flowchart of a method of vacuum forming a cover material over edges of a substrate for the interior trim part.

### DETAILED DESCRIPTION

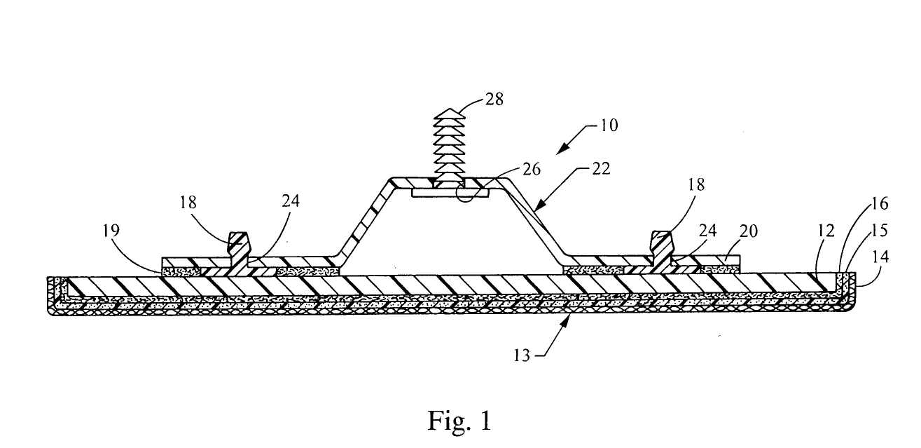

Now referring to FIG. 1, an interior trim part embodying the principles of the present invention is illustrated therein and designated as 10. The interior trim part 10 includes a substrate 12, a cover material 13, a web adhesive 16 and an inner panel 20.

The substrate 12 is preferably made from a porous material, such as Azdel™ material manufactured by General Electric (GE) Plastics. Azdel™ is approximately 55% glass fiber and 45% polypropen resin. The porous material may be supplied in sheets of various weights ranging from 800 to 2000 grams per square meter. The substrate 12 provides structural support to the interior trim part 10. The cover material 13 is disposed over the substrate 12. The outer layer 14 of the cover material 13 is exposed to the vehicle occupant when the interior trim panel is integrated into a vehicle and is generally referred to as the “A” surface. Polyvinylchloride (PVC) or a thermoplastic polyolefin (TPO) cover material can be used to produce a soft touch feel and smooth appearance desired for interior trim applications. Using PVC or TPO cover material 13 and the substrate 12 provides the interior trim part 10 having a very low thermal expansion which is produced with approximately 30% less weight than conventional injection molded parts. The cover material 13 also includes a foam layer 15 to improve the soft touch feel of the interior trim part 10 and mask any surface defects in the substrate 12. Preferably, the foam layer 15 is approximately 1 mm thick. A web adhesive 16 is disposed between the cover material 13 and the substrate 12 to bond the cover material 13 to the substrate 12.

The interior trim part 10 may also include an inner panel 20. The inner panel 20 is also preferably made of a porous material, e.g., Azdel™ material. The inner panel 20 is attached to the substrate 12 by fasteners 18. Fasteners 18 may be attached to the substrate 12 by adhesive or other means. The fasteners 18 attach to the inner panel 20 through holes 24 in the inner panel 20. Alternatively, the inner panel 20 may be also directly bonded to the substrate 12 by an adhesive layer 19. The inner panel 20 includes a doghouse portion 22. The doghouse portion 22 provides structural support to the interior trim part 10 and provides a location for attachment within a vehicle. The inner panel 20 further includes a hole 26 allowing a fastener 28 to provide attachment to the vehicle through the hole 26.

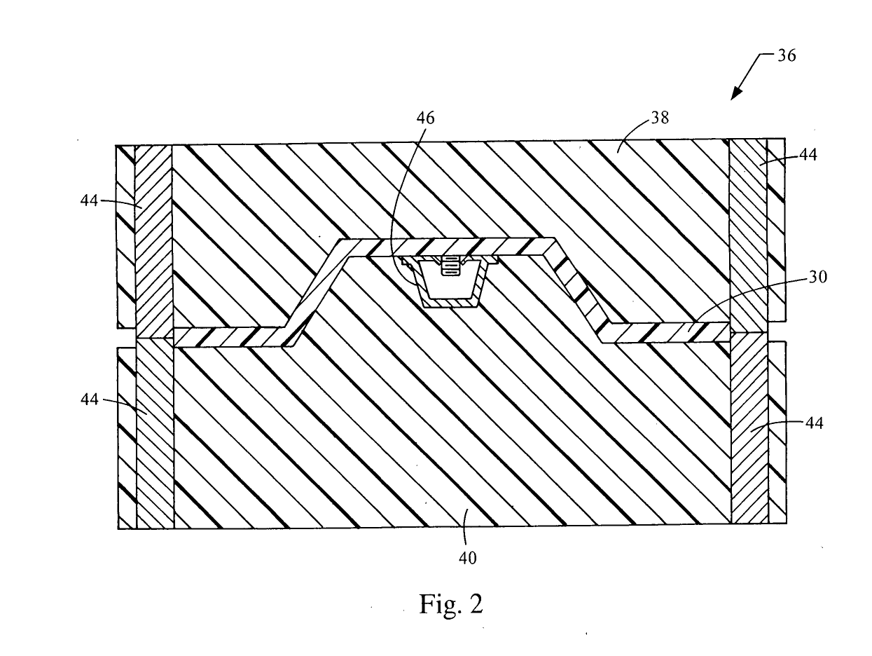

Referring to FIG. 2, the sheet 30 is loosely positioned in the forming tool 36 freely between a first mold part 38 and a second mold part 40. It is to be noted that sheet 30 is disposed between the first mold part 38 and the second mold part 40 without a pin frame construction. Rather, a sheet of the porous material is freely placed between the first mold part 38 and the second mold part 40. Pressure is then applied on the sheet 30 by the first mold part 38 and the second mold part 40. Approximately 10 to 50 pounds per square inch (psi) of pressure is exerted by the tool 36 on the sheet 30 to form the sheet 30. The tool 36 is preferably constructed using a composite material thereby providing significant cost savings as compared to steel tools. Preferably, the tool 36 is made of high grade Ren board which may be manufactured by Cibgi™. Tool 36 also includes steel stock posts 44 to limit the closure of the tool 36 and pressure exerted on the sheet 30. A fastener 46 may be inserted into the tool 36 during the forming process and thereby attaching the fastener 46 to the sheet 30.

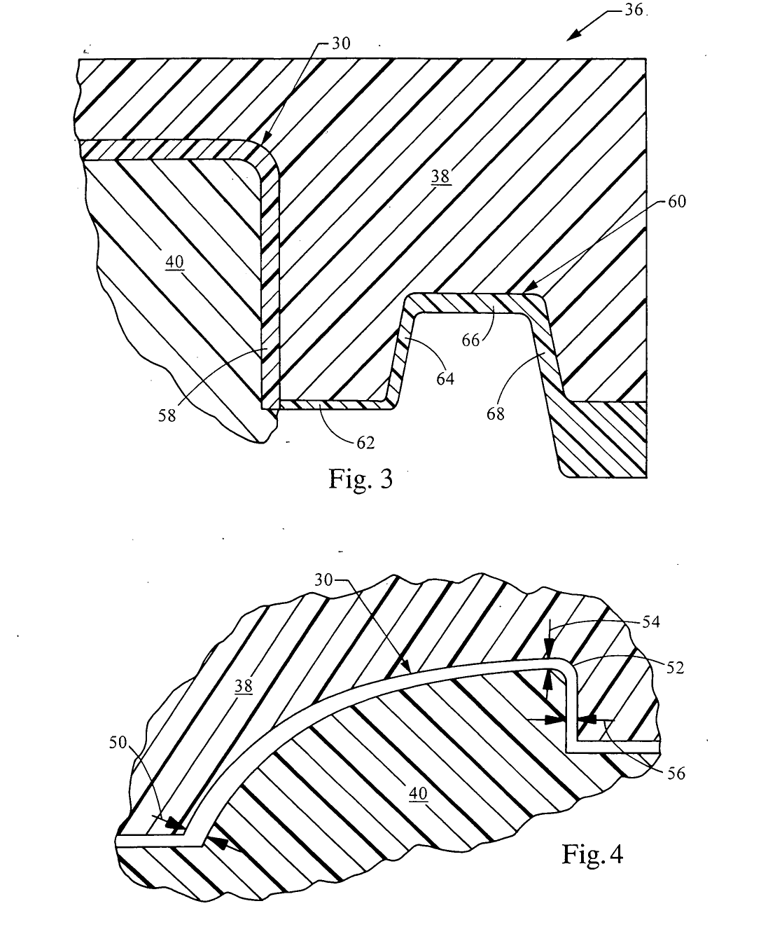

Referring to FIG. 3, for forming sections of the sheet 30 that are deep drawn as indicated by reference 58, the tool 36 includes a retaining portion or C-shaped section 60. The C-shaped section includes a first portion 62 extending from the deep drawn wall with a reduced thickness of about 1 mm and a length of about 15 mm. A second portion 64 of the C-shaped section has a draft angle of about 2° and a reduced thickness of about 1.5 mm. A third portion 66 of the C-shaped section extends approximately parallel to the first section and having a thickness of about 2.5 mm, while the fourth portion 68 of the C-shaped section 60 again includes a 2° draft angle. The use of such a C-shaped section provides tension during forming of sheet 30 to freely retain the substrate within the first and second mold parts 38, 40, thereby eliminating the need of a pin frame construction of the forming tool. The retaining portion also provides an ability to form complex or deep configurations of interior trim panels while avoiding tearing and ripping of the substrate. As a result, the retaining portion prevents wrinkles and helps to eliminate the use of material retention features in the tool.

Now referring to FIG. 4, the general thickness of the resulting sheet 30 is about 2-3 mm and more specifically about 2.5 mm as indicated by reference 50. However, in a tight radius of about 2.5 mm as indicated by reference numeral 52, the thickness of portions before the bend 54 and after the bend 56 are preferably reduced to about 1-2 mm and more specifically about 1.5 mm.

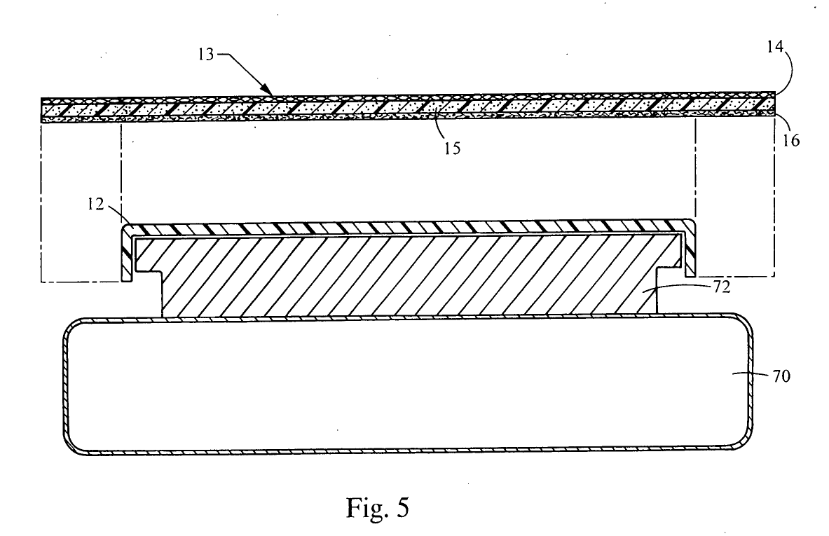

Referring to FIG. 5, an apparatus for vacuum forming a cover material over the substrate is provided. During the vacuum forming process, the substrate 12 is disposed on a fixture that is configured to support the substrate 12. Web adhesive 16 is attached to the cover material 13, and preferably the web adhesive 16 is laminated to the cover material 13. The cover material 13 and web adhesive 16 are suspended over the substrate 12 and heated from both sides to soften the web adhesive 16 and cover material 13 simultaneously. The cover material 13 and adhesive 16 are heated to approximately 275° F. prior to vacuum forming. A vacuum form box 70 creates a vacuum that is transferred to the substrate 12 through passages in the vacuum formed fixture 72.

The unique porous properties of the substrate 12, especially when made of Azdel™ material, allow the vacuum to be transferred through the substrate 12 to the web adhesive 16 and cover stock 13 without having to form additional holes in the substrate 12. During the vacuum forming, the adhesive web 16 is drawn into the substrate 12 due to its porous nature. This promotes the adhesion of the cover material 13 to the substrate 12. In addition, the porous nature of the substrate 12 enables the cover material 13 to wrap around the edge of the substrate 12 and bond thereto.

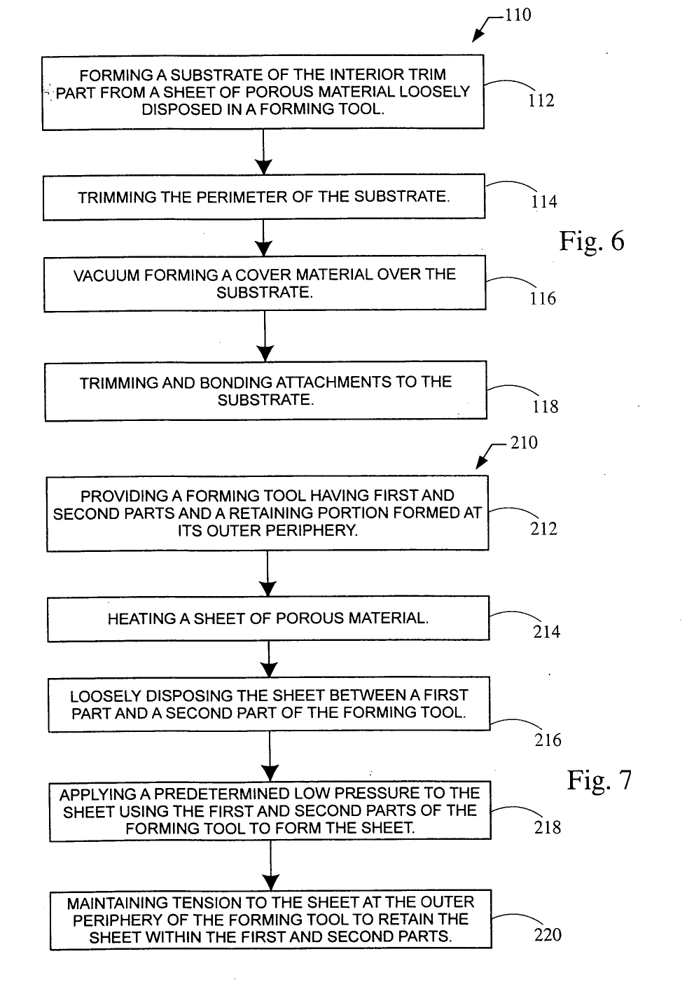

In accordance with one embodiment of the present invention, FIG. 6 illustrates a general method 110 of producing an interior trim part. Method 110 generally comprises forming a substrate of the interior trim part from a sheet of a porous material loosely disposed in a forming tool in step 112 and trimming the perimeter of the substrate in step 114 after forming the substrate. The method 110 further includes vacuum forming a cover material over edges of the substrate in step 116 after trimming and bonding attachments to the substrate in step 118.

FIG. 7 illustrates a method 210 of forming a porous material for producing an interior trim part. As shown, the method 210 comprises providing a forming tool having first and second parts and a retaining portion formed at its outer periphery in step 212, and heating a sheet of porous material in step 214. The sheet 30 is heated to approximately 450° F. The method 210 further includes loosely disposing the sheet between a first part and a second part of the forming tool in step 216. As mentioned above, the substrate made of porous material is formed while being retained freely between the first and second parts of the tool, eliminating the need of a pin frame configuration. The method 210 further includes applying a predetermined low pressure to the sheet using the first and second parts of the forming tool to form the sheet in step 218 and maintaining tension to the sheet at the outer periphery of the forming tool to retain the sheet within the first and second parts in step 220. The retaining portion provides adequate tension to the sheet at it outer periphery to retain the sheet within the first and second parts of the tool.

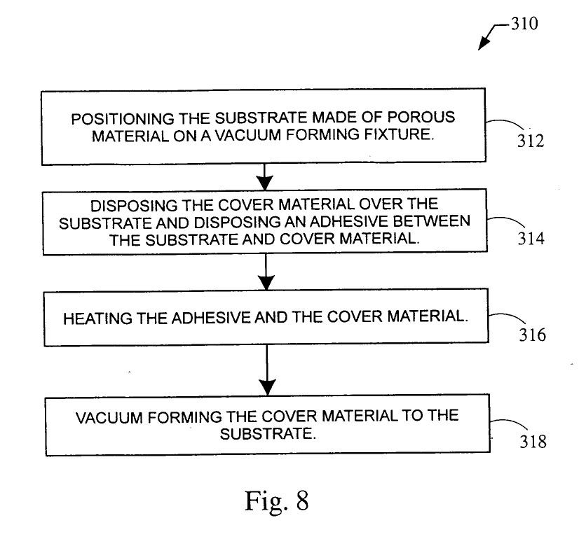

FIG. 8 illustrates a method 310 of vacuum forming a porous material for producing an interior trim part. In this embodiment, method 310 comprises positioning the substrate made of porous material on a vacuum forming fixture in step 312. An example of the vacuum forming fixture may be the vacuum form box 70 shown in FIG. 5. Method 310 further includes disposing the cover material over the substrate and disposing an adhesive between the substrate and cover material in step 314. The cover material may include a foam layer for added structure and support to the substrate. The method 310 further comprises heating the adhesive and the cover material in step 316, and vacuum forming the cover material to the substrate in step 318. In this embodiment, the substrate is made of Azdel™ to provide the substrate with a porous property which allows the vacuum to be created through the substrate and form the cover material to the substrate.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. An apparatus for forming a substrate from a sheet of a porous material, the substrate being of an interior trim part for a vehicle compartment, the apparatus comprising:
a first mold part;
a second mold part opposite the first mold part, the second part cooperating with the first mold part to receive the sheet and define a predetermined shape of the substrate; and
a retaining portion formed at an outer periphery of the first and second mold parts, the retaining portion configured to maintain tension to the sheet at the outer periphery during forming of the substrate to freely retain the sheet between the first and second mold parts.

2. The apparatus according to claim 1, wherein the first and second mold part are configured to apply between 10 and 50 PSI of pressure to the sheet.

3. The apparatus according to claim 1, wherein the retaining portion is a generally C-shaped section.

4. The apparatus according to claim 1, wherein the first mold part is made of Ren board.

5. The apparatus according to claim 1, wherein the second mold part is made of Ren board.

6. An apparatus for forming a substrate from a sheet of a porous material, the substrate being of an interior trim part for a vehicle compartment, the apparatus comprising:
a first mold part;
a second mold part opposite the first mold part, the second mold part cooperating with the first mold part to receive the sheet, the first and second mold parts defining general and radius portions of the substrate, the first and second mold parts having a clearance of about 2 to 3 millimeters at the general portions and about 1 to 2 millimeters at the radius portions; and
a retaining portion formed at an outer periphery of the first and second mold parts, the retaining portion configured to maintain tension to the sheet at the outer periphery during forming of the substrate to retain the sheet between the first and second parts.

7. The apparatus according to claim 6, wherein the first and second part are configured to apply between 10 and 50 PSI of pressure to the sheet.

8. The apparatus according to claim 6, wherein the retaining portion is a generally C-shaped section.

9. The apparatus according to claim 6, wherein the first mold part is made of Ren board.

10. The apparatus according to claim 6, wherein the second mold part is made of Ren board.

11. A method for producing an interior trim part for a vehicle compartment, the method comprising:
forming a substrate of the interior trim part from a sheet of porous material loosely disposed in a forming tool;
trimming a perimeter of the substrate;
vacuum forming a cover material over the substrate;
trimming and bonding attachments to the substrate.

12. The method according to claim 11, wherein the step of forming the substrate includes:
providing the forming tool having a first and second part and a retaining portion formed at its outer periphery;
heating the sheet of porous material;
disposing the sheet between the first part and the second part of the forming tool;
applying a predetermined low pressure to the sheet using the first and second part of the forming tool to form the sheet; and
maintaining tension to the sheet at the outer periphery of the forming tool to retain the sheet freely within the first and second part.

13. The method according to claim 12, wherein the substrate material is heated to about 450° F.

14. The method according to claim 12, wherein the predetermined low pressure is between 10 and 50 PSI.

15. The method according to claim 11, wherein the step of vacuum forming includes:
positioning the substrate made of a porous material on a vacuum forming fixture;
disposing the cover material over the substrate and disposing an adhesive between the substrate and the cover material;
heating the adhesive and the cover material; and
vacuum forming the cover material to the substrate.

16. The method according to claim 15, wherein the adhesive is heated to about 250° F.

17. A method for forming a substrate from a sheet of porous material, the substrate being of an interior trim part for a vehicle compartment, the method comprising:
providing a forming tool having a first and second part and a retaining portion formed at its outer periphery;
heating the sheet of porous material;
disposing the sheet freely between the first part and the second part of the forming tool;
applying a predetermined low pressure to the sheet using the first and second part of the forming tool to form the sheet; and
maintaining tension to the sheet at the outer periphery of the forming tool to retain the sheet freely within the first and second part.

18. The method according to claim 17, wherein the substrate material is heated to about 450° F.

19. The method according to claim 17, wherein the predetermined low pressure is between 10 and 50 PSI.

20. A method for vacuum forming a cover material over a substrate of an interior trim part for a vehicle compartment, the method comprising:
positioning the substrate made of a porous material on a vacuum forming fixture;
disposing the cover material over the substrate and disposing an adhesive between the substrate and the cover material;
heating the adhesive and the cover material; and
vacuum forming the cover material to the substrate.

21. The method according to claim 20, wherein the substrate includes Azdel.

22. The method according to claim 20, wherein the vacuum is created through the porous material to form the cover material to the substrate.

23. The method according to claim 22, wherein the vacuum created through the porous substrate is configured to draw the adhesive into the porous material of the substrate.

24. The method according to claim 20, wherein the adhesive is heated to about 275° F.

25. The method according to claim 20, wherein the adhesive is a web adhesive.

26. The method according to claim 25, wherein the web adhesive is laminated to the cover material.
